(19) United States
(12) Patent Application Publication
(10) Pub. No.: US 2006/0095561 A1
(43) Pub. Date: May 4, 2006

(54) Method and apparatus to correlate system management information using instant messaging facilities

(75) Inventors: Rhonda L. Childress, Austin, TX (US); Ward K. Harold, Austin, TX (US); David Bruce Kumhyr, Austin, TX (US); Neil R. Pennell, Cedar Creek, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/976,255

(22) Filed: Oct. 28, 2004

(51) Int. Cl. G06F 15/173; G06F 15/16

(52) U.S. Cl. 709/224; 709/206

(57) ABSTRACT

An improved method, apparatus, and computer instructions for correlating system management information in a network data processing system. Monitoring an instant messaging chat group for system management information sent by a set of agents located in the network data processing system using an instant messaging system, wherein the system management information forms collected system management information, correlating the collected system management information form correlated system management information, and initiating an action based on the correlated system management information.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for correlating system management information in a network data processing system.

2. Description of Related Art

A virtual enterprise may provide various services within an organization or to users on the Internet. A virtual enterprise in a business entity constructed from organizationally and geographically distributed units or groups. For example, a company, such as International Business Machines Corporation, has various micro electronics providers and independent resellers. The company along with these providers and resellers forms a virtual enterprise if a system is implemented to integrate key business systems with participating business units from these different companies. In providing these services, the proper functioning of components across the enterprise is essential. These other components include, for example, servers, routers, printers, gateways, and firewalls. A failure in one or more of these components may result in an inability to provide the services that are expected by users for customers of the virtual enterprise. All of these components are found in a network data processing system, which may have various sizes depending on the enterprise. Additionally, these components may be located in diverse geographic locations. As a result, management information about all of these components must be collected.

The system management information about the components are correlated and analyzed to access the performance and availability of a particular service being provided by the virtual enterprise. System management information is the information needed to monitor and manage a specific component in a network data processing system. The information collected may include information with respect to loading or requests being made to various components. Further, this management information also may include, for example, status information about the availability of resources within a particular component. These resources may include available processing power, available memory, and available storage space on hard disk drives.

Thus, it would be advantageous to have an improved method, apparatus, and computer instructions for correlating system management information in a network data processing system.

### SUMMARY OF THE INVENTION

The present invention provides an improved method, apparatus, and computer instructions for correlating system management information in a network data processing system. An instant messaging chat group for system management is monitored for information sent by a set of agents located in the network data processing system using an instant messaging system. The system management information forms collected system management information. The collected system management information is correlated to form correlated system management information and an action is initiated based on the correlated system management information.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in correlating system management information in accordance with a preferred embodiment of the present invention;

FIG. 5 is a diagram illustrating components used to correlate system information through an instant messaging system in accordance with a preferred embodiment of the present invention;

FIG. 6 is a diagram illustrating correlation of information by management agents is depicted in accordance with a preferred embodiment of the present invention;

FIG. 7 is a flowchart of a process for sending system management information to a chat group in accordance with a preferred embodiment of the present invention; and

FIG. 8 is a flowchart of a process is for collecting and correlating system management information is depicted in accordance with a preferred embodiment of the present invention.

### DETAILED DESCRIPTION OF THE PREFERRED EMBODIMENT

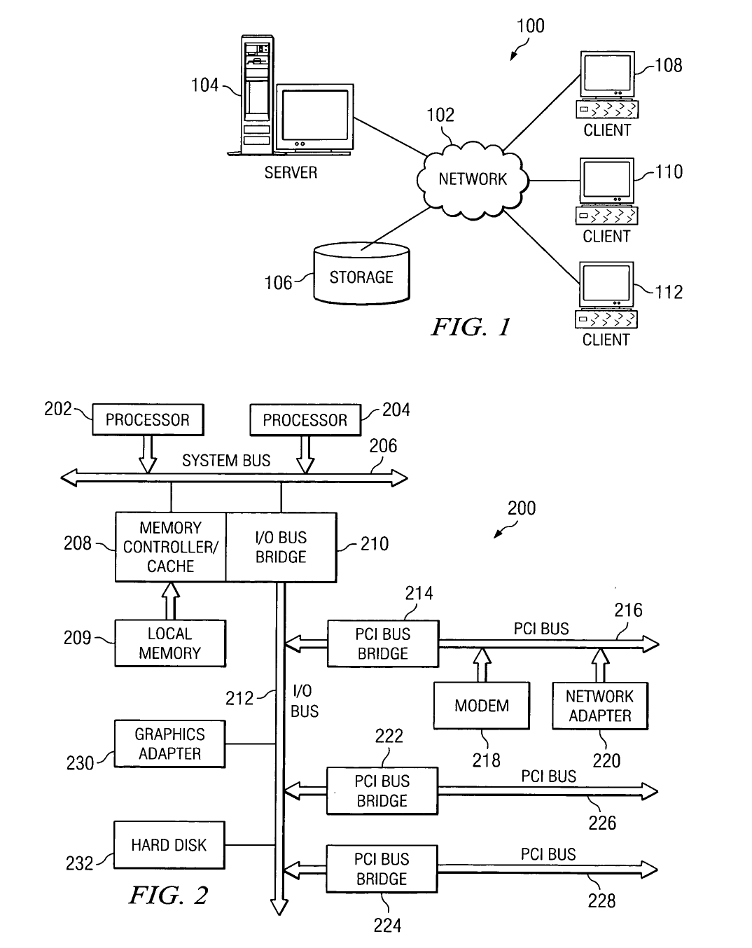

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

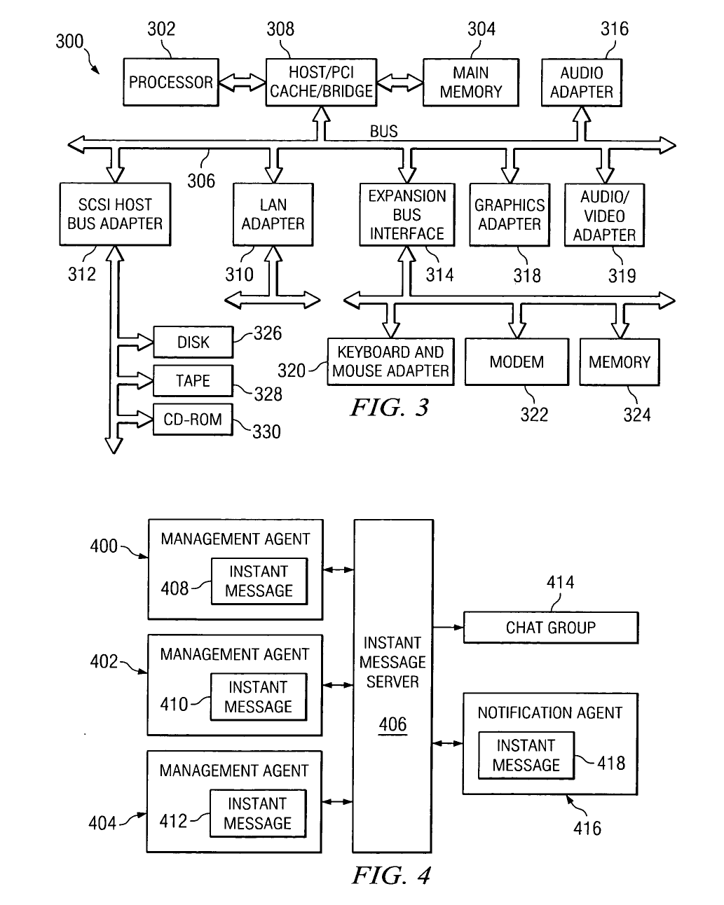

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer instructions for correlating system management information in a network data processing system. System management information is information needed to monitor and manage one or more components in a network data processing system. The specific information that forms system management information varies depending on the type of component. For example, with a router, the number of packets transferred may be pertinent system management information, while for a Web server, the system management information may be the number of hits per second for a particular universal resource locator (URL). This information is typically collected and made available through instrumentation or software built into the managed components. Various standards, such as simple network management protocol (SNMP) for hardware devices and common information module (CIM) or Java management extensions (JMX) for software components are used to provide access to the information collected by the components. The mechanism of the present invention uses an instant messaging chat group as a place to monitor for the presence of system management information. This chat group is a location to which a set of agents located in a network data processing system may send system management information. The chat group may include one or more management agents, which are present to receive information from the set of agents.

This information is sent through an instant messaging system. The different agents may include instant messaging processes similar to those used by users to communicate with each other. The mechanism of the present invention modifies this system to allow agent processes to send information collected about components within the network data processing system. The information gathered in the instant messaging chat group is correlated and used to initiate any action that may be necessary.

With reference now to FIG. 4, a diagram illustrating components used in correlating system management information is depicted in accordance with a preferred embodiment of the present invention. In this example, management agents 400, 402, and 404 are present. These management agents send system management information to instant messaging (IM) server 406. Depending on the particular type of instant messaging system, the instant messaging agents may send instant messages to each other directly once logging in with instant message server 406.

These management agents monitor components, such as servers, gateways, and network attached storage systems. Information collected by these management agents are sent to instant messenger 406 through instant messaging processes that are incorporated within the agents. In these examples, management agent 400 contains instant messaging (IM) process 408, management agent 402 contains instant messaging (IM) process 410, and management agent 404 contains instant messaging (IM) process 412. These instant messaging agents use protocols implemented and currently available in instant messaging programs that are used by human users. The instant messaging processes in these management agents log on to instant messaging server 406 and send information to a particular chat group, such as chat group 414. This chat group may include a number of management agents that are designated for receiving system management information.

Notification agent 416 contains instant messaging process 418. Notification agent 416 logs on to instant messaging server 406 through instant messaging process 418. This particular component monitors system management information sent to chat group 414. In particular, notification agent 416 collects the system management information sent to chat group 414 by management agents 400, 402, and 404. This information is gathered from chat group 414 through instant messaging process 418 in notification agent 416.

This notification agent may then correlate the information and initiate necessary actions depending on the particular implementation. Alternatively, notification agent 416 may collect system management information from chat group 414 and send this information to another program for analysis.

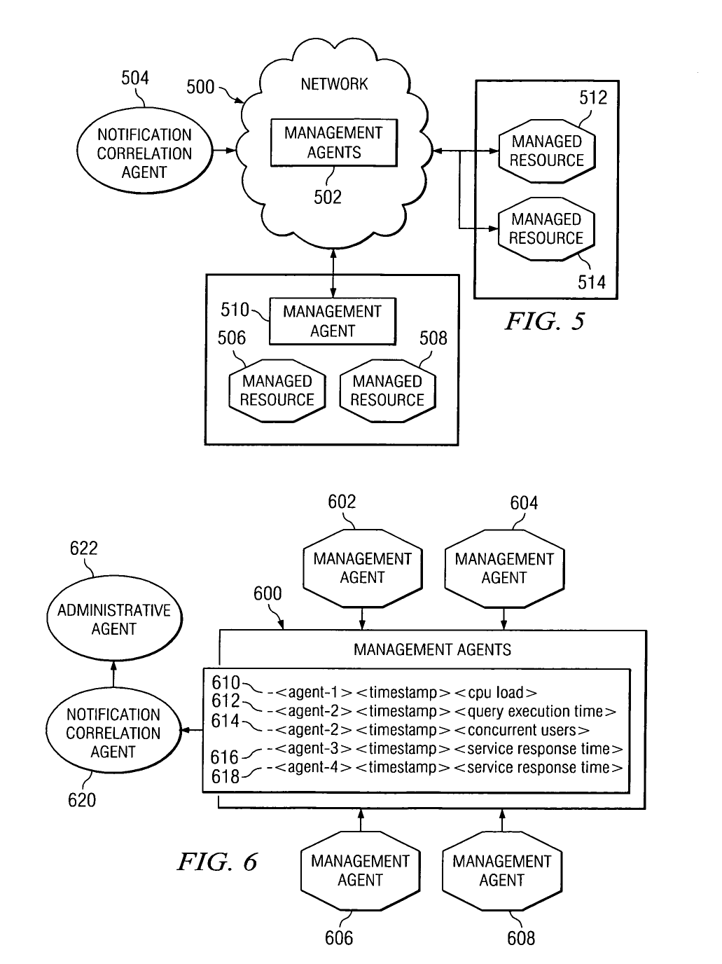

Turning next to FIG. 5, a diagram illustrating components used to correlate system information through an instant messaging system is depicted in accordance with a preferred embodiment of the present invention. In this illustrative example, network 500 includes an ability to process instant messaging messages. In particular, network 500 may include an instant messaging server, such as instant messaging server 406 in FIG. 4. This server is provided to facilitate receiving and exchanging messages between different agents within the network data processing system. Management agents 502 are present for receiving system management information from different management agents that monitor various components within network 500. Management agents 502 send system management information for correlation to notification correlation agent 504.

As a particular example, managed resource 506 and managed resource 508 are monitored by management agent 510. Management agent 510 sends system management information regarding managed resource 506 and managed resource 508 to the chat group formed by management agents 502.

Management agents illustrated in this example are similar to the management agents illustrated and described with respect to FIG. 4. Each of these management agents includes instant messaging capabilities to send system management information to multi user chat group 504 for correlation. Of course not all resources may be monitored. In this example, managed resource 512 and managed resource 514 are not monitored by management agents.

System management information sent to multi user chat group 504 is monitored by notification correlation agent 516 this agent collects the system management information from the chat group formed by management agents 502 and correlates the information. In the illustrative examples, correlation takes place across different disparate system management information sources. For example, a management application may correlate hits per second for a Web server, a processor load for an application server, and the average query response time for a database system when deciding whether to bring an additional Web server online. In other words, correlation involves analyzing the system management information collected from the different managed resources to determine if any action needs to be taken. Other actions may include, for example, sending alerts to an administrator, restarting a server, initiating updates to an operating system or application, or initiating actions to reduce temperature for a computer.

Based on the analysis performed, certain actions may be taken. For example, an alert may be generated and sent to an administrator or system operator.

Additionally, processes in managed resources may be restarted. For example, if managed resource 506 is a disk drive and the help of the disk drive is low based on fragmentation of files, notification correlation agent 516 may initiate a defragmentation process for managed resource 506. Other actions may include rerouting traffic from one managed resource to another managed resource if a particular managed resource is unable to handle current traffic loads. Basically, management agents 502 and management agent 510 log in to an instant messaging server that handles this multi user chat group formed by management agents 502. These management agents send system management information to multi user chat group. An automated agent, such as notification correlation agent 504 or some other management agent within management agents 502 collect and correlate the information sent to multi user chat group formed by management agents 502. With the correlation of the information, appropriate action may then be taken. Notification correlation agent 504 may forward higher-level events for notifications to human operators or send messages back to the service components. Service components include management agents and or managed resources. These messages may include commands for some action that is to be taken. The messages may be sent to the management agents or even directly to the managed resources.

Turning next to FIG. 6, a diagram illustrating correlation of information by management agents is depicted in accordance with a preferred embodiment of the present invention. In this illustrative example, management agents 600 monitor a chat room for system management information. The system management information is sent to management agents 600 through agents monitoring components and resources within a network data processing system.

In these examples, management agents 602, 604, 606, and 608 send system management information to management agents 600. These agents are ones that are employed to monitor different resources within the network data processing system. In this example, this information is sent through an instant messaging system. In particular, the information is sent in a manner similar to the sending of text by instant messengers from one user to another user.

As management agents 600 receive the system management information. Message 610 was sent from management agent 606 to management agents 600 in this example. The system management information contains the cpu or processor load information along with a timestamp identifying when the message was sent. Message 612 was sent by management agent 604 and contains query execution time and a timestamp. Message 614 was sent by management agent 606 and contains a timestamp and an identification of concurrent users. Message 616 was sent by management agent 608 in this example and identifies service response time for the resource being monitored by management agent 608 along with a timestamp. Message 618 was sent by management agent 602 to management agents 600. This message includes a service response time and a timestamp for the resource being monitored by management agent 602.

The information received by management agents 600 are collected by notification correlation agent 620. This particular component correlates the incoming messages received by management agents 600. In response to correlating the information, higher-level administrative notifications may be generated to administrative agent 622 in this example. This notification may be, for example, an email message or some other alert that is received by administrative agent 622. Depending on the particular implementation, notification correlation agent 620 may send messages back to agents 602, 604, 606, or 608. These messages may include, for example, alerts for display at the resources or commands to initiate actions at the resources.

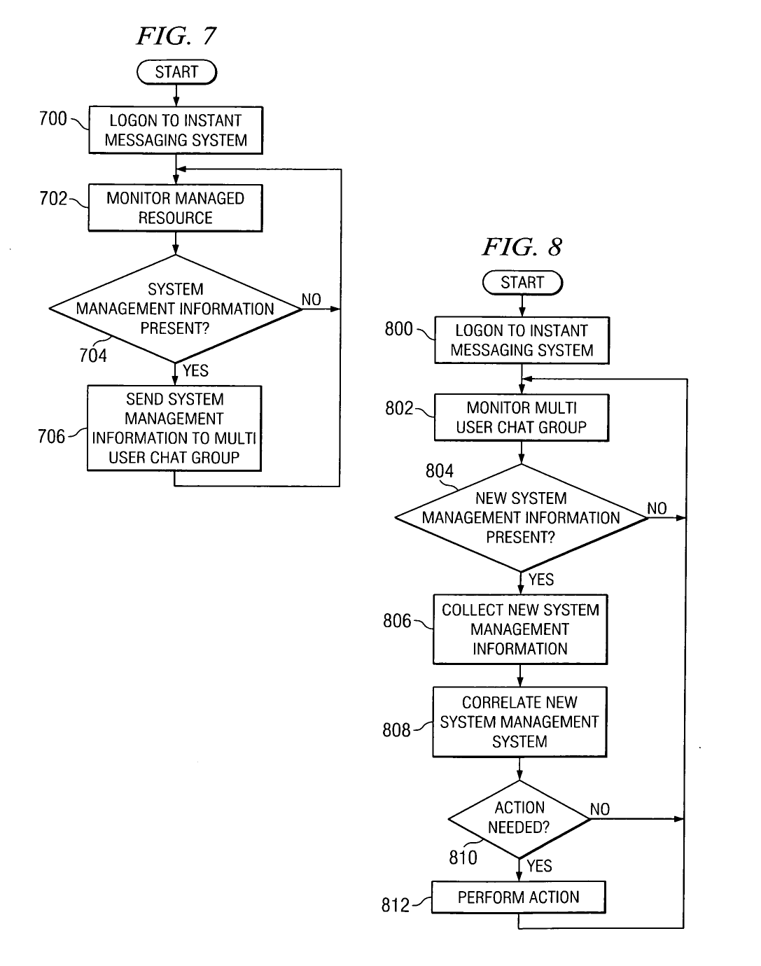

Turning now to FIG. 7, a flowchart of a process for sending system management information to a chat group is depicted in accordance with a preferred embodiment of the present invention. The process illustrated in FIG. 7 may be implemented in an agent, such as management agent 510 in FIG. 5.

In this example, the process begins by logging on to the instant messaging system (step 700). The managed resource or resources assigned to the agent are monitored (step 702). The particular agent may monitor a single resource or multiple resources depending on the particular implementation. A determination is made as to whether management information is present (step 704). If management information is not present, the process returns to step 702.

Otherwise, the management information is sent to the multi user chat group (step 706) and the process returns to step 702. In sending information to the multi user chat group, the process may send the message to a particular management agent or agents that are designated for receiving these messages.

The system management information may be monitored or collected in the chat session using different mechanisms. For example, a parser looking for key terms or tags may be used. Additionally, a common extensible markup language (XML) schema understood by the different agents may be used.

The management information being monitored for may vary depending on the particular managed resource being monitored. For example, if the managed resource is a server, users, loading of the cpu, and response time are examples of system management information that may be monitored in other cases, other information, such as temperature within a server or processor may be monitored. Amount of free memory and storage space are other examples of system management information that may be monitored by an agent for a particular resource.

With reference next to FIG. 8, a flowchart of a process for collecting and correlating system management information is depicted in accordance with a preferred embodiment of the present invention. The process illustrated in FIG. 8 may be implemented in an agent, such as notification correlation agent 516 in FIG. 5.

The process begins by logging on to the instant messaging system (step 800). Thereafter, a multi user chat group is monitored (step 802). This monitoring may occur by waiting to see if messages are received from management agents in the chat group. In this example, the process waits for messages to be forwarded to the agent for management agents in a chat group that collect information from agents monitoring resources within the network data processing system.

A determination is made as to whether new system management information is present (step 804). If no new information is present, the process returns to step 802.

Otherwise, the new system management information is collected (step 806). Thereafter, the new system management information is correlated (step 808). A determination is then made as to whether action is needed (step 810). If action is not needed, the process returns to step 802. Otherwise, the action needed is performed (step 812) with the process then returning to step 802. As mentioned above, the action may take different forms. The action may include sending higher-level notifications to a user or sending messages back to the agents monitoring the managed resources.

Thus, the present invention provides an improved method, apparatus, and computer instructions for using instant messaging chat facilities to correlate system management information across a network data processing system. The mechanism of the present invention employs at least one agent to monitor an instant messaging multi user chat group to collect and correlate system management information sent to a chat group by agents monitors service components. The management agents responsible for the service components log into the instant messaging system and send system management information to the multi user chat group.

Depending on the particular implementation, the management agents may be implemented within the service components themselves, rather than being a separate entity. The management agents are shown as a separate entity for purposes of explaining the invention, but do not imply that the function of the management agents must be a separate component from the managed resource.

An automated agent belonging to the chat group collects the system management information. This agent correlates this information and takes the appropriate action. As mentioned before, this action may include sending notifications to higher-level or returning messages to the agents or resources. Additionally, the process that correlates information may be separate from the process that collects the information from the chat group.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for correlating system management information in a network data processing system, the method comprising:
monitoring an instant messaging chat group for system management information sent by a set of agents located in the network data processing system using an instant messaging system, wherein the system management information forms collected system management information;
correlating the collected system management information to form correlated system management information; and
initiating an action based on the correlated system management information.

2. The method of claim 1, wherein the set of agents are a set of service components.

3. The method of claim 1, wherein the initiating step includes:
sending an alert to a human operator.

4. The method of claim 1, wherein the initiating step includes:
sending a message to an agent in the set of agents.

5. The method of claim 1, wherein the network data processing system is a virtual enterprise.

6. The method of claim 1, wherein the set of agents login to the instant messaging system to send the system management information to the instant messaging chat group.

7. A data processing system for correlating system management information in a network data processing system, the data processing system comprising:
a bus system;
a communications unit connected to the bus system;
a memory connected to the bus system, wherein the memory includes a set of instructions; and
a processing unit connected to the bus system, in which the processing unit executes the set of instructions to monitor an instant messaging chat group for system management information sent by a set of agents located in the network data processing system using an instant messaging system, in which the system management information forms collected system management information; correlate the collected system management information to form correlated system management information; and initiate an action based on the correlated system management information.

8. A data processing system for correlating system management information in a network data processing system, the method comprising:
monitoring means for monitoring an instant messaging chat group for system management information sent by a set of agents located in the network data processing system using an instant messaging system, wherein the system management information forms collected system management information;
correlating means for correlating the collected system management information to form correlated system management information; and
initiating means for initiating an action based on the correlated system management information.

9. The data processing system of claim 8, wherein the set of agents are a set of service components.

10. The data processing system of claim 8, wherein the initiating means includes:
sending means for sending an alert to a human operator.

11. The data processing system of claim 8, wherein the initiating means includes:
sending means for sending a message to an agent in the set of agents.

12. The data processing system of claim 8, wherein the network data processing system is a virtual enterprise.

13. The data processing system of claim 8, wherein the set of agents login to the instant messaging system to send the system management information to the instant messaging chat group.

14. A computer program product in a computer readable medium for correlating system management information in a network data processing system, the computer program product comprising:
first instructions for monitoring an instant messaging chat group for system management information sent by a set of agents located in the network data processing system using an instant messaging system, wherein the system management information forms collected system management information;
second instructions for correlating the collected system management information to form correlated system management information; and
third instructions for initiating an action based on the correlated system management information.

15. The computer program product of claim 14, wherein the set of agents are a set of service components.

16. The computer program product of claim 14, wherein the third instructions includes:
sub-instructions for sending an alert to a human operator.

17. The computer program product of claim 14, wherein the third instructions includes:
sub-instructions for sending a message to an agent in the set of agents.

18. The computer program product of claim 14, wherein the network data processing system is a virtual enterprise.

19. The computer program product of claim 14, wherein the set of agents login to the instant messaging system to send the system management information to the instant messaging chat group.
